(19) United States
(12) Patent Application Publication
(10) Pub. No.: US 2014/0082048 A1
(43) Pub. Date: Mar. 20, 2014

(54) NETWORK SERVICES PROVIDED IN CLOUD COMPUTING ENVIRONMENT

(71) Applicants: Yousef A. Khalidi, Bellevue, WA (US); Deepak Bansal, Sammamish, WA (US); Changhoon Kim, Bellevue, WA (US); Srikanth Kandula, Redmond, WA (US); David A. Maltz, Bellevue, WA (US); Parveen Kumar Patel, Redmond, WA (US); Albert Gordon Greenberg, Seattle, WA (US)

(72) Inventors: Yousef A. Khalidi, Bellevue, WA (US); Deepak Bansal, Sammamish, WA (US); Changhoon Kim, Bellevue, WA (US); Srikanth Kandula, Redmond, WA (US); David A. Maltz, Bellevue, WA (US); Parveen Kumar Patel, Redmond, WA (US); Albert Gordon Greenberg, Seattle, WA (US)

(73) Assignee: MICROSOFT CORPORATION, Redmond, WA (US)

(21) Appl. No.: 13/620,267

(22) Filed: Sep. 14, 2012

(51) Int. Cl. G06F 15/16

(52) U.S. Cl. 709/203

(57) ABSTRACT

A cloud computing environment providing a network service for a client computing entity. The network service is not an application level service, but rather a service that operates at or below the network layer in the protocol stack. For instance, the network service might be a network endpoint service such as a network address service (such as DNS) or a dynamic network service (such as DHCP), or a network traffic service such as a firewall service or a secure tunneling service (such as VPN). The service might also provide a pipeline of network services for network level traffic to and from the client computing entity. The cloud environment uses policy to determine which of a plurality of communication channels to use when exchanging cloud service data for the network service.

### BACKGROUND

“Cloud computing” is a model for enabling ubiquitous, convenient, on-demand network access to a shared pool of configurable computing resources (e.g., networks, servers, storage, applications, and services). The shared pool of configurable computing resources can be rapidly provisioned via virtualization and released with low management effort or service provider interaction, and then scaled accordingly. A cloud computing model can be composed of various characteristics (e.g., on-demand self-service, broad network access, resource pooling, rapid elasticity, measured service, etc), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.). An environment that implements the cloud computing model is often referred to as a cloud computing environment.

Typically, a cloud computing environment offers up multiple services to customers. Such customers might be an enterprise, or individual consumers. In any case, such customers are typically provisioned with a client computing system (hereinafter also referred to as “clients”), and the customers connect to the services over a network. Such clients typically have access to a number of networking capabilities including, at a most fundamental level, Domain Name Server (DNS) functionality, which allows a client machine to discover the Internet Protocol (IP) address of remote sites using a more user-readable domain name. For clients that do not have static IP addresses, the clients also have access to a Dynamic Host Configuration Protocol (DHCP) server. For individual clients or for enterprises, it can further be helpful to have a firewall, which protects the client from harmful network traffic. Furthermore, enterprises often provide a Virtual Private Network (VPN) server, which allows clients external to the enterprise network to securely connect to systems internal to the enterprise network.

### BRIEF SUMMARY

At least one embodiment described herein relates to a cloud computing environment providing a network service for a client computing entity. The network service is not an application level service, but rather a service that operates at or below the network layer in the protocol stack. For instance, the network service might be a network endpoint service such as a network address service (such as DNS) in which a network address (such as an Internet Protocol (IP) address) is extracted from a more human-readable domain name that the client computing entity is using to navigate. The network endpoint service might also be a dynamic network service (such as DHCP) in which a dynamic network address is repeatedly assigned to the client computing entity. The network service might also be a network traffic service such as a firewall service or a secure tunneling service (such as a Virtual Private Network (VPN) service) that provides a secure tunneling channel between the client computing entity and a node within a secure network. Thus, the network services are not the target application-level service, but rather the network service provides the support to allow for connection and communication with such application-level services. The cloud environment uses policy to determine which of a plurality of communication channels to use when exchanging cloud service data for the network service.

This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 illustrates a computing system in which some embodiments described herein may be employed;

FIG. 2 illustrates a distributed system in which a client computing entity is in communication with a cloud computing environment over a group of one or more communication channels;

FIG. 3 illustrates an example of the pipeline service of FIG. 3;

FIG. 4 illustrates a flowchart of a method for performing a cloud network service;

FIG. 5 illustrates a distributed system that includes an enterprise environment and a cloud computing environment in which a cloud service is performed on behalf of the enterprise environment, and in which a delivery controller manages which channel cloud data is communicated over in accordance with the principles described herein;

FIG. 6 illustrates a flowchart of a method for communicating cloud service data from an enterprise environment to a cloud service in a cloud computing environment using a delivery controller to select which communication channel to use in exchanging cloud data in accordance with the principles described herein;

FIG. 7 abstractly illustrates a cloud computing environment in which the principles described herein may be employed; and

FIG. 8 abstractly illustrates a host computing system as including virtual machines, a hypervisor, physical resources and a host agent.

### DETAILED DESCRIPTION

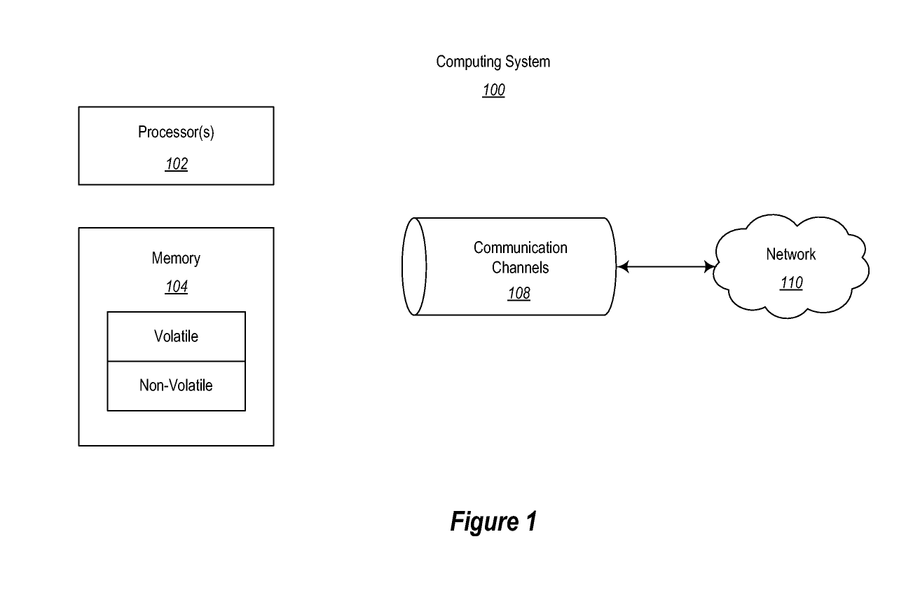

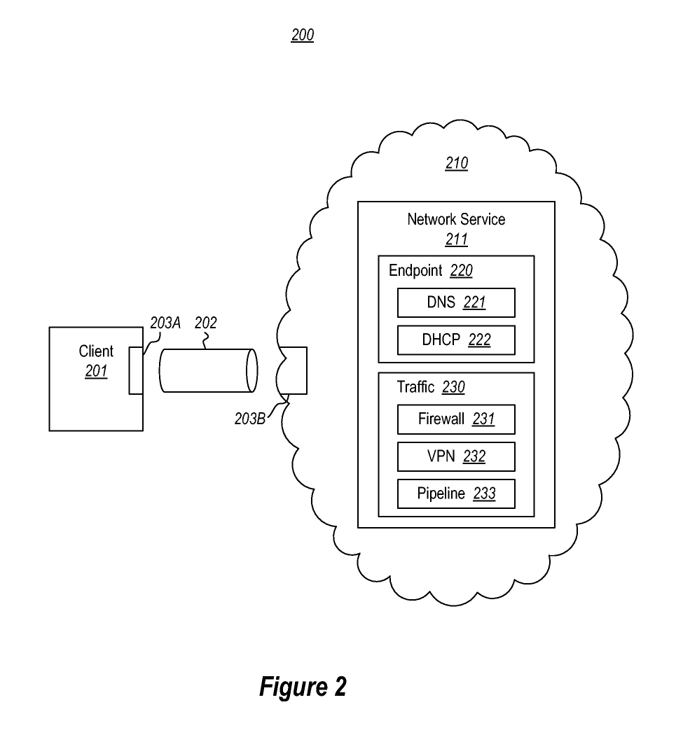

At least one embodiment described herein relates to a cloud computing environment providing a network service for a client computing entity. The network service is not an application level service, but rather a service that operates at or below the network layer in the protocol stack. For instance, the network service might be a network endpoint service or a network traffic service. In either case, the network services are not the target application-level service, but rather the network service provides the support to allow for connection and communication with such application-level services. The cloud environment uses policy to determine which of a plurality of communication channels to use when exchanging cloud service data for the network service. First, some introductory discussion regarding computing systems will be described with respect to FIG. 1. Then, embodiments of the system will be described with respect to FIGS. 2 through 8.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having thereon computer-executable instructions that may be executed by the processor. The memory may take any form and may depend on the nature and form of the computing system. A computing system may be distributed over a network environment and may include multiple constituent computing systems.

As illustrated in FIG. 1, in its most basic configuration, a computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

In the description that follows, embodiments are described with reference to acts that are performed by one or more computing systems. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 104 of the computing system 100. Computing system 100 may also contain communication channels 108 that allow the computing system 100 to communicate with other message processors over, for example, network 110.

Embodiments described herein may comprise or utilize a special purpose or general-purpose computer including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

FIG. 2 illustrates a distributed system 200 in which a client computing entity 201 is in communication with a cloud computing environment 210 over a group of one or more communication channels 202. The client computing entity 201 may be a client computing system, in which case, it may be structured like the computing system 100 described above with respect to FIG. 1. However, the client computing entity may also be a virtual machine that emulates a client computing system. In order to communicate over communication channel(s) 202, the client computing system 201 has a communication module 203A and the cloud computing entity 210 has a communication module 203B.

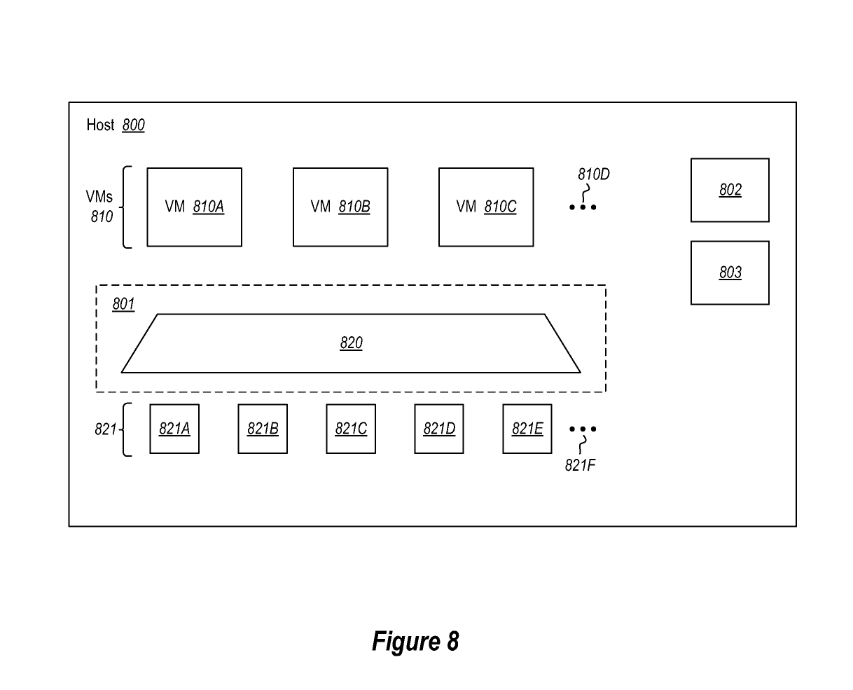

There are multiple places the functionality of communication module 203A and 203B can be located. Examples include: 1) as a software library running on one or more servers in the cloud computing environment 210 or at the client computing entity 201, either as a process or part of the operating system kernel; 2) as software running as part of a hypervisor (such as hypervisor 820 of FIG. 8) or as a physical service below the hypervisor; 3) as software or hardware running on a device that is part of the communication channel 530 (i.e., “middleboxes”) which can run on servers or network equipment such as routers or switches. The exact choice of location is a function of cost, performance, and maintainablility, and different choices of implementation and location can be made for 203A and 203B.

In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For instance, cloud computing is currently employed in the marketplace so as to offer ubiquitous and convenient on-demand access to the shared pool of configurable computing resources. Furthermore, the shared pool of configurable computing resources can be rapidly provisioned via virtualization and released with low management effort or service provider interaction, and then scaled accordingly.

A cloud computing model can be composed of various characteristics such as on-demand self-service, broad network access, resource pooling, rapid elasticity, measured service, and so forth. A cloud computing model may also come in the form of various service models such as, for example, Software as a Service (“SaaS”), Platform as a Service (“PaaS”), and Infrastructure as a Service (“IaaS”). The cloud computing model may also be deployed using different deployment models such as private cloud, community cloud, public cloud, hybrid cloud, and so forth. In this description and in the claims, a “cloud computing environment” is an environment in which cloud computing is employed.

The cloud computing environment contains a network service 211 that provides network services for the client computing entity 201 as well as potentially for other client computing entities not illustrated within FIG. 2. The network service 211 is not an application-level service, but rather is a service offered to allow connection to and/or communication with such application-level services. For instance, the network service 211 may be performed at or below the network layer in a protocol stack. For instance, the network service might operate at or below layer three in the Open Systems Interconnection (OSI) model.

As examples only, the network service 211 may include a network endpoint service 220 that allows for proper discovery of the network address (e.g., such as an Internet Protocol (IP) address) of the client or a service offered to the client.

For instance, a network endpoint service 220 may be a network address service 221 that the client computing entity may use to extract a network address (e.g., an IP address) from a domain name. An example of such a network address service 221 is a Domain Name Server (DNS) service. This might be accomplished by reconfiguring the client computing entity 201 to correspond with the network address service 221 rather than a DNS server external to the cloud computing environment 210, or at least external to the network service 211. For instance, the IP address of the network address service 221 may be substituted for the IP address of the external DNS service in the client computing entity. If, for example, the client computing entity were a virtual machine, the management component on the host computing system that hosts the virtual machine may discover the address of the network address service 221 and provide that address to the virtual machine. Thus, in this case, the client computing entity may have DNS like services without having to install a DNS server, or otherwise have access to a DNS server directly.

Another example of a network endpoint service 220 is a dynamic address service 222 that may be used to assign a dynamic network address (e.g., a dynamic IP address) to the client computing entity. For instance, the dynamic address service 222 may implement Dynamic Host Configuration Protocol (DHCP). In this case, rather that the client computing entity communicating with a local DHCP server for periodic assignment of a dynamic IP address, the client computing entity may instead be configured to communicate with the dynamic address service 222 for such periodic assignments of dynamic addresses.

As further examples only, the network service 211 may include a network traffic service 230 that allows for proper routing of network traffic at the network level. For instance, a network traffic service 230 may be a firewall service 231 in which incoming and/or outgoing network traffic is monitored and perhaps blocked depending on characteristics of that network traffic. When communicating with an address external to the firewalled network, the client computing entity 201 communicates the network traffic first to the firewall service 231, which evaluates characteristics of the outgoing network traffic, and determines whether to block the network traffic, allow the network traffic to pass, or perform other appropriate action. When an entity external to the firewalled service communicates to the client computing entity 201, the client computing entity first communicates with the firewall service 231, which evaluates characteristics of the incoming network traffic, and determines whether to block or allow the incoming network traffic and/or perform other appropriate action.

Another example of a network traffic service 230 may be a secure tunneling service 232 that sets up a secure tunneling channel in which the client computing entity may securely communicate over a public network using the secure tunneling channel to an entity internal to an enterprise network. An example of the secure tunneling service 232 might be a Virtual Private Network component. Such a VPN service performs functions of a VPN service by setting up a secure tunnel channel between the client computing entity and another entity, such that these communications may be securely communicated over a public network, such as the Internet.

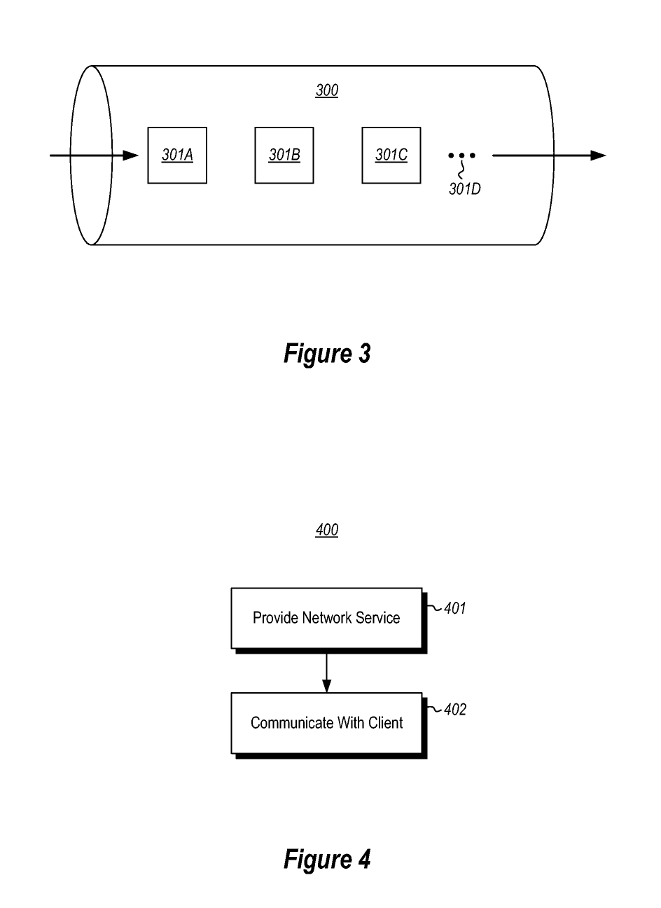

The network traffic service may also include a pipeline service 233 in which inbound and/or outbound network traffic is subject to one or more components of sequential processing. For instance, FIG. 3 illustrates a pipeline service 300 in which the service has constructed a sequence of processing components 301A, 301B, and 301C through which the network traffic is to be passed during processing. The ellipses 301D symbolically represents that there may be any number or components in the pipeline, from as few as one, or even perhaps zero in some cases, with no upper limit. The pipeline may be constructed by the pipeline service depending on the type of network traffic.

As examples, the components in the pipeline might include an auditing component that tracks statistics associated with the network traffic and/or tracks associated charges. For instance, the statistics and/or charges may be tracked on a per user and/or per account basis.

The components in the pipeline might also include a compression/extraction component that compresses and/or extracts the payload of the network packets. The components in the pipeline might also include an encryption/decryption component that encrypts and/or decrypts the payload of the network packets. The pipeline components might also include a firewall component.

FIG. 4 illustrates a flowchart of a method 400 for performing a cloud network service. The method includes an act of a cloud computing environment providing a network service (act 401) that is configured to operate for the client computing entity at or below a network level in a protocol stack. For instance, referring to FIG. 2, the cloud computing environment 210 provides network service 211. The cloud computing environment communicates with the client computing entity over a network to support the network service (act 402). For instance, the network communication associated with several example network services have been described above with respect to the network address service 221, the dynamic address service 222, the firewall service 231, the secure tunneling service 232, and the pipeline service 233.

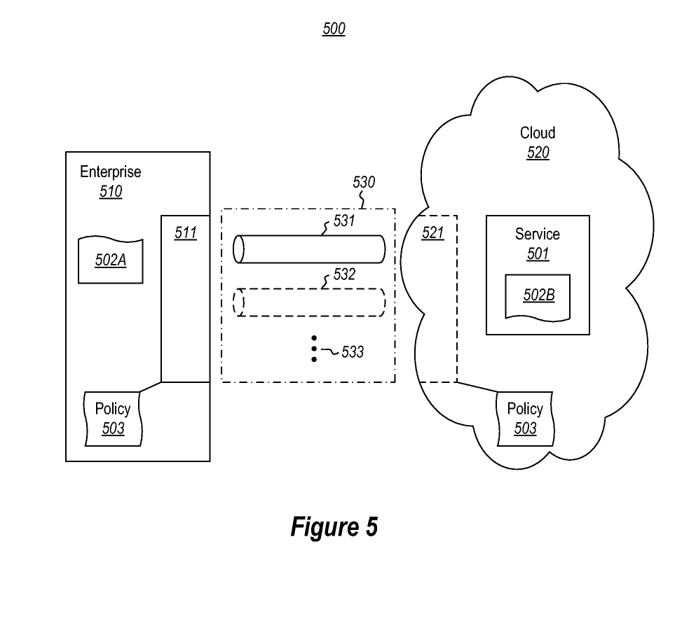

FIG. 5 illustrates an example 500 of the distributed environment 200 of FIG. 2. In this case, the client computing entity is included within an enterprise environment 510 although not required. The cloud service 501 is included within the cloud computing environment 520. The cloud service 501 is an example of the network service 211 of FIG. 2. The cloud computing environment 520 is an example of the cloud computing environment 210 of FIG. 2.

The enterprise environment 510 may any environment in the control of an enterprise. In this description and in the claims, an “enterprise” is any legal entity in which multiple people collaborate for a common purpose. Examples of an enterprise include a business entity (such as a corporation, company, partnership, firm, division, or the like), a government entity (such as a local, state, federal agency, or international bodies), an ecclesiastical entity (such as a church, diocese, synagogue, mosque, or the like), educational entities (such as universities, schools), medical entities (such as a hospital, or doctor office) standards bodies, of any other entity in which multiple individuals collaborate.

Some of the data (i.e., cloud service data 502B) associated with the cloud service 501 is maintained within the cloud computing environment 520 perhaps by the cloud service 501 itself. Other cloud service data 502A is maintained within the enterprise environment 510. As the cloud service 501 progresses, cloud service data 502 is exchanged between the enterprise environment 510 and the cloud computing environment 520. When exchanging cloud service data, the enterprise environment 510 and the cloud computing environment 520 may use any one of a number of communication channels 530. The communication channels 530 are an example of the one or more communication channels 202 of FIG. 2.

For instance, the communication channels 530 are illustrated as including channels 531 and 532, although the ellipses 533 represents that there may be more than two available channels for communication between the enterprise environment 510 and the cloud computing environment 520. As an example, the communication channel 531 might be a dedicated channel for use between the enterprise environment 510 and the cloud computing environment 520. The dedicated channel 531 may be for exclusive use for communication between these two nodes. Perhaps the dedicated channel 531 may have a guaranteed minimum bandwidth. Furthering the example, the communication channel 532 might be a non-dedicated channel (such as the Internet) that is not for exclusive use between the enterprise environment 510 and the cloud computing environment. However, the principles described herein are not limited to these example communication channel types.

The enterprise environment 510 includes an enterprise-side delivery controller 511 that is configured to select which of the communication channels 530 to transfer cloud service data over depending on enterprise policy 503. For instance, the enterprise-side delivery controller 511 may decide which channel to use when transferring cloud service data from the enterprise environment 510 to the cloud computing environment 520. The cloud computing environment 520 also may include a cloud-side delivery controller 521 that is configured to select which of the communication channels 530 to transfer cloud service data over also depending on the enterprise policy 503. For instance, the cloud-side delivery controller 521 may decide which channel to use when transferring cloud service data from the cloud computing environment 510 to the enterprise environment 520.

In some embodiments, the enterprise policy 503 may be application-level policy. For instance, the decision may be based on one or more, or all, of the following considerations: financial considerations, latency considerations, transfer speed considerations, reliability considerations, business goal considerations, security considerations, resource management considerations, deadlines associated with the service, and importance of the data or service. However, other considerations may be evaluated when determining which channel 530 to use when transferring the cloud service data.

For instance, financial considerations might include a cost of transmitting data of each of the channels 530. A higher cost for transmission might tend more towards more judicious use of that channel, whereas a lower cost for transmission might tend more towards more liberal use of that channel.

Latency considerations involve the latency associated with each channel. If data or circumstances are less sensitive to latency, this would weigh less against the use of higher latency channels that this would if the data and circumstances were more sensitive to latency.

Transfer speed considerations involve the transfer speed desired for the data. If data or circumstances make higher speed transfer more desirable, this might tend the decision towards the use of higher speed channels as compared to if the data and circumstances did not warrant such high transfer speeds.

Reliability considerations involve the reliability of the communication channels. For instance, if the data requires guaranteed delivery, then more reliable communication channels might be used. If the data is sensitive to bit error rate, then the more reliable communication channels might be used. If the communication channel has a guaranteed minimum level of reliability which satisfies the need, then that would suggest use of the more reliable communication channel.

Business goal considerations may also be considered. For instance, perhaps a business goal is to keep the data as secure as possible. In that case, security considerations would warrant a more secure channel (e.g., such as a dedicated channel). The security consideration might also consider whether the data is transmitted in encrypted form or not. If not, and the data is sensitive, this would suggest the use of a secure communication channel.

Resource management considerations might involve levels of current usage of the channel. For instance, if a channel has most of its bandwidth used, and another channel has lower bandwidth utilization, this might lean the decision towards the use of the communication channel that has lower bandwidth utilization.

If there is a deadline associated with the data or the service, the faster communication channel might be used. If the data or service has a high importance, then it might be worth it to use the more expensive channel if the communication is faster and/or more secure.

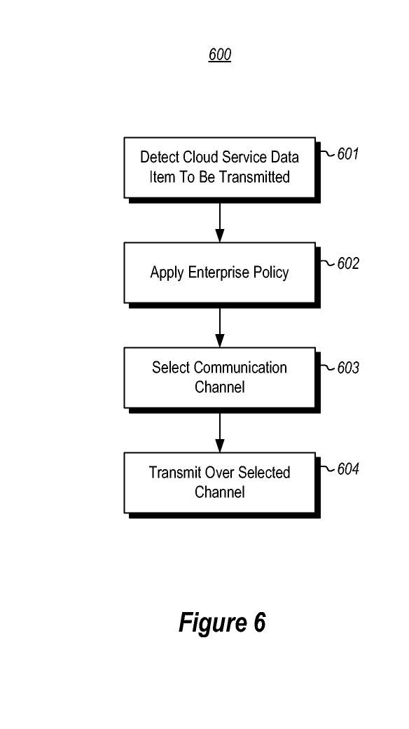

FIG. 6 illustrates a flowchart of a method 600 for communicating cloud service data from an enterprise environment to a cloud service in a cloud computing environment. For instance, the method 600 may be performed in the system 500 of FIG. 5, and thus will now be described with frequent reference to system 500 of FIG. 5. The method 600 may be performed by the enterprise-side delivery controller 511 each time an item of cloud service data is to be transmitted from the enterprise environment 510 to the cloud computing environment 520. The method 600 may likewise be performed by the cloud-side delivery controller 521 each time an item of cloud service data is to be transmitted from the cloud computing environment 520 to the enterprise environment 510.

The method 600 is initiated upon detecting that cloud service data is to be transmitted (act 601). In the case of the enterprise-side delivery controller 511, the cloud service data is to be transmitted from the enterprise environment 510 to the cloud computing environment 520. In the case of the cloud-side delivery controller 521, the cloud service data is to be transmitted from the cloud computing environment 520 to the enterprise environment 510. The appropriate delivery controller 511 or 521 then enumerates the potential communication channels 530 to determine which are available and healthy. The appropriate controller then applies enterprise policy to the item of cloud service data (act 602) to select one of the communication channels 530 over which to communicate the cloud service data (act 603). The appropriate delivery controller 511 or 521 then transmits the cloud service data item over the selected communication channel 530 (act 604).

Thus, depending on the business goals of the enterprise, the delivery controller 511 or 521 may transmit cloud service data associated with a single cloud service over different communication channels to advance the goals of the enterprise. The delivery controller 511 or 521 may perform other functions other than selecting communication channels based on policy. For instance, the delivery controller 511 or 521 may also perform caching of cloud service data associated with the cloud service. This is advantageous in cases in which the delivery controller 511 or 521 might likely need to transmit such data to the other party in the enterprise/cloud pair.

FIG. 5 illustrates a system 500 in which a single enterprise environment 510 communicates with a single cloud computing environment 520. However, the principles may be extended to an environment in which multiple enterprise environments are communicating with a single cloud computing environment, and/or in which multiple cloud computing environments are communicating with a single enterprise environment.

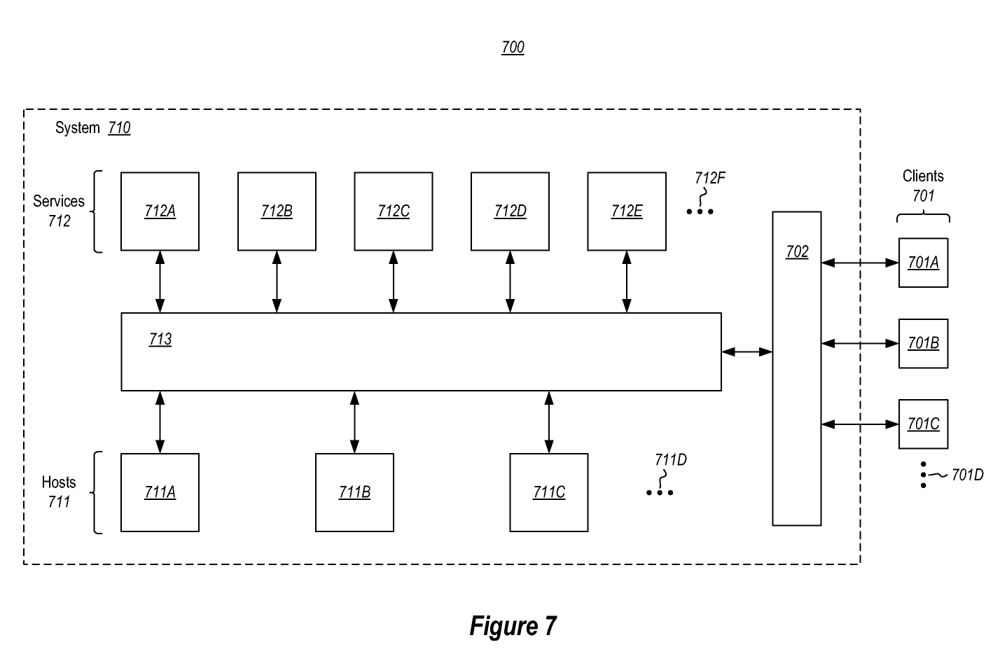

FIGS. 7 and 8 illustrate an embodiment of a cloud computing environment that may represent the cloud computing environment 210 or 500 of FIG. 2 or 5. FIG. 7 abstractly illustrates a cloud computing environment in which the principles described herein may be employed. The environment 700 includes multiple clients 701 interacting with a system 710 using an interface 702. The environment 700 is illustrated as having three clients 701A, 701B and 701C, although the ellipses 701D represent that the principles described herein are not limited to the number of clients interfacing with the system 710 through the interface 702. The system 710 may provide services to the clients 701 on-demand and thus the number of clients 701 receiving services from the system 710 may vary over time.

Each client 701 may, for example, be structured as described above for the computing system 100 of FIG. 1. Alternatively or in addition, the client may be an application or other software module that interfaces with the system 710 through the interface 702. The interface 702 may be an application program interface that is defined in such a way that any computing system or software entity that is capable of using the application program interface may communicate with the system 710.

The system 710 may be a distributed system, although not required. In one embodiment, the system 710 is a cloud computing environment. Cloud computing environments may be distributed, although not required, and may even be distributed internationally and/or have components possessed across multiple organizations.

The system 710 includes multiple hosts 711, that are each capable of running virtual machines. Although the system 700 might include any number of hosts 711, there are three hosts 711A, 711B and 711C illustrated in FIG. 7, with the ellipses 711D representing that the principles described herein are not limited to the exact number of hosts that are within the system 710. There may be as few as one, with no upper limit. Furthermore, the number of hosts may be static, or might dynamically change over time as new hosts are added to the system 710, or as hosts are dropped from the system 710. Each of the hosts 711 may be structured as described above for the computing system 100 of FIG. 1.

Each host is capable of running one or more, and potentially many, virtual machines. For instance, FIG. 8 abstractly illustrates a host 800 in further detail. As an example, the host 800 might represent any of the hosts 711 of FIG. 7. In the case of FIG. 8, the host 800 is illustrated as operating three virtual machines 810 including virtual machines 810A, 810B and 810C. However, the ellipses 810D once again represents that the principles described herein are not limited to the number of virtual machines running on the host 800. There may be as few as zero virtual machines running on the host with the only upper limit being defined by the physical capabilities of the host 800.

During operation, the virtual machines emulates a fully operational computing system including an at least an operating system, and perhaps one or more other applications as well. Each virtual machine is assigned to a particular client, and is responsible to support the desktop environment for that client.

The virtual machine generates a desktop image or other rendering instructions that represent a current state of the desktop, and then transmits the image or instructions to the client for rendering of the desktop. For instance, referring to FIGS. 7 and 8, suppose that the host 800 of FIG. 8 represents the host 711A of FIG. 7, and that the virtual machine 810A is assigned to client 701A (referred to herein as “the primary example”), the virtual machine 810A might generate the desktop image or instructions and dispatch such instructions to the corresponding client 701A from the host 711A via a service coordination system 713 and via the system interface 702.

As the user interacts with the desktop at the client, the user inputs are transmitted from the client to the virtual machine. For instance, in the primary example and referring to FIGS. 7 and 8, the user of the client 701A interacts with the desktop, and the user inputs are transmitted from the client 701 to the virtual machine 810A via the interface 701, via the service coordination system 713 and via the host 711A.

The virtual machine processes the user inputs and, if appropriate, changes the desktop state. If such change in desktop state is to cause a change in the rendered desktop, then the virtual machine alters the image or rendering instructions, if appropriate, and transmits the altered image or rendered instructions to the client computing system for appropriate rendering. From the prospective of the user, it is as though the client computing system is itself performing the desktop processing.

The host 800 includes a hypervisor 820 that emulates virtual resources for the virtual machines 810 using physical resources 821 that are abstracted from view of the virtual machines 810. The hypervisor 821 also provides proper isolation between the virtual machines 810. Thus, from the perspective of any given virtual machine, the hypervisor 820 provides the illusion that the virtual machine is interfacing with a physical resource, even though the virtual machine only interfaces with the appearance (e.g., a virtual resource) of a physical resource, and not with a physical resource directly. In FIG. 8, the physical resources 821 are abstractly represented as including resources 821A through 821F. Examples of physical resources 821 including processing capacity, memory, disk space, network bandwidth, media drives, and so forth.

The host 800 may operate a host agent 802 that monitors the performance of the host, and performs other operations that manage the host. Furthermore, the host 800 may include other components 803.

Referring back to FIG. 7, the system 700 also includes services 712. In the illustrated example, the services 700 include five distinct services 712A, 712B, 712C, 712D and 712E, although the ellipses 712F represent that the principles described herein are not limited to the number of service in the system 710. A service coordination system 713 communicates with the hosts 711 and with the services 712 to thereby provide services requested by the clients 701, and other services (such as authentication, billing, and so forth) that may be prerequisites for the requested service.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
a client computing entity; and
a cloud computing environment that is communicatively coupled to the client computing entity over a plurality of communication channels,
wherein the cloud computing environment performs a network service for the client computing entity, and the policy accessible to the client computing entity is used to determine which of the plurality of communication channels to use when exchanging cloud service data for the network service.

2. The system in accordance with claim 1, wherein the network service operates at or below layer 3 of the Open Systems Interconnection (OSI) model.

3. The system in accordance with claim 1, wherein the client computing entity is a client computing system.

4. The system in accordance with claim 1, wherein the client computing entity is a virtual machine.

5. The system in accordance with claim 1, wherein the network service comprises a network endpoint service.

6. The system in accordance with claim 5, wherein the network endpoint service is a network address service that the client may use to extract an Internet Protocol (IP) address from a domain name.

7. The system in accordance with claim 5, wherein the network endpoint service is a dynamic address service that may be used to assign a dynamic Internet Protocol (IP) address to the client computing entity.

8. The system in accordance with claim 1, wherein the network service comprises a network traffic service.

9. The system in accordance with claim 8, wherein the network traffic service comprises a firewall service.

10. The system in accordance with claim 8, wherein the network traffic service comprises a secure tunneling service that sets up a secure tunneling channel in which the client computing entity may securely communicate over a public network using the secure tunneling channel to an entity internal to an enterprise network.

11. The system in accordance with claim 8, wherein the network traffic service comprises a pipeline service in which inbound and/or outbound network traffic is subject to a plurality of processing components within a pipeline.

12. The system in accordance with claim 11, wherein the plurality of processing components include an auditing component.

13. The system in accordance with claim 11, wherein the plurality of processing components include compression and extraction component.

14. The system in accordance with claim 11, wherein the plurality of processing components including encryption and decryption.

15. The system in accordance with claim 11, wherein the plurality of processing components include a firewall component.

16. The system in accordance with claim 1, wherein the at least one communication channel comprise a plurality of communication channels.

17. The system in accordance with claim 16, wherein the plurality of communication channels comprises a dedicated computing channel, and a non-dedicated computing channel.

18. The system in accordance with claim 16, wherein the client computing entity has thereon a delivery controller configured to select which of the plurality of communications channels to use when communicating between the client computing entity and the cloud computing environment.

19. A computing system comprising:
a communication module configured to permit communication with a client computing entity over a plurality of communication channels; and
a network service that is configured to operate for the client computing entity at or below a network level in a protocol stack, and configured to perform at least one of a network address service, a dynamic address service, a firewall service, and a secure tunneling service, the network service using policy accessible to the computing system to determine which of the plurality of communication channels to use when exchanging cloud service data for the network service.

20. A method for performing a cloud network service, the method comprising:
an act of a cloud computing environment providing a network service that is configured to operate for the client computing entity at or below a network level in a protocol stack, and configured to perform at least one of a network address service, a dynamic address service, a firewall service, and a secure tunneling service; and
an act of the cloud computing environment communicating with the client computing entity over a a plurality of communication channels to support the network service, and using policy to determine which of the plurality of communication channels to use when exchanging cloud service data for the network service.
